(19) United States
(12) Patent Application Publication
(10) Pub. No.: US 2008/0014654 A1
(43) Pub. Date: Jan. 17, 2008

(54) Efficient fluorimetric analyzer for single-walled carbon nanotubes

(75) Inventors: R. Bruce Weisman, Houston, TX (US); Sergei M. Bachilo, Houston, TX (US); John-David R. Rocha, Missouri City, TX (US); John P. Casey, Houston, TX (US)

Correspondence Address: Robert C. Shaddox;Winstead Sechrest & Minick P.C., P.O. Box 50784, Dallas, TX, 75201, US

(73) Assignee: William Marsh Rice University, Houston, TX (US)

(21) Appl. No.: 11/281,784

(22) Filed: Nov. 16, 2005

Related U.S. Application Data
(60) Provisional application No. 60/629,447, filed on Nov. 19, 2004.

(51) Int. Cl. G01N 21/64

(52) U.S. Cl. 436/172; 436/171; 422/82.08

(57) ABSTRACT

The present invention is directed toward methods and devices for analyzing populations of single-wall carbon nanotubes (SWNTs) on the basis of their fluorescence properties and the comparison of said properties to fluorescence profiles of pre-determined SWNT compositions. Generally, such analyzing yields information about the composition of the SWNTs within said population. Such information includes, for example, the relative abundances of semiconducting SWNTs, the diameter distribution of such SWNTs, and the relative abundances of one or more particular SWNT species—as identified by one or more specific nanotube indices (n,m). The methods and devices of the present invention provide for the analysis of SWNT compositions in a rapid and efficient manner.

### RELATED APPLICATIONS

This application claims priority to and benefit of U.S. Provisional Application Ser. No. 60/629,447, filed on Nov. 19, 2004, entitled “Efficient Fluorimetric Analyzer for Single-Walled Carbon Nanotubes”, by inventor Weisman et al.

The present invention was made with support from the National Science Foundation, Grant Nos. NSF CHEM-0314270 and EEC-1008007; and the National Aeronautics and Space Administration, Grant No. NASA NNJ04HD88G.

### FIELD OF THE INVENTION

This invention relates generally to carbon nanotubes, and more specifically to devices and methods for analyzing their fluorescent signatures for the purpose of making compositional determinations.

### BACKGROUND

Carbon nanotubes (CNTs), comprising multiple concentric shells and termed multi-wall carbon nanotubes (MWNTs), were discovered by Iijima in 1991 [Iijima, Nature 1991, 354, 56-58]. Subsequent to this discovery, single-wall carbon nanotubes (SWNTs), comprising single graphene sheets rolled up on themselves to form cylindrical tubes with nanoscale diameters, were synthesized in an arc-discharge process using carbon electrodes doped with transition metals [Iijima et al., Nature 1993, 363, 603-605; and Bethune et al., Nature 1993, 363, 605-607]. These carbon nanotubes (especially SWNTs) possess unique mechanical, electrical, thermal and optical properties, and such properties make them attractive for a wide variety of applications. See Baughman et al., Science, 2002, 297, 787-792.

Methods of making CNTs include the following techniques: arc discharge [Ebbesen, Annu. Rev. Mater. Sci. 1994, 24, 235-264]; laser oven [Thess et al., Science 1996, 273, 483-487]; flame synthesis [Vander Wal et al., Chem. Phys. Lett. 2001, 349, 178-184]; and chemical vapor deposition [U.S. Pat. No. 5,374,415], wherein a supported [Hafner et al., Chem. Phys. Lett. 1998, 296, 195-202] or an unsupported [Cheng et al., Chem. Phys. Lett. 1998, 289, 602-610; Nikolaev et al., Chem. Phys. Lett. 1999, 313, 91-97] metal catalyst may also be used.

Techniques of suspending and chemically functionalizing CNTs have greatly facilitated the ability to manipulate these materials, particularly for SWNTs which tend to assemble into rope-like aggregates [Thess et al., Science, 1996, 273, 483-487]. Such suspending techniques typically involve dispersal of CNTs with surfactant and/or polymer material [see Strano et al., J. Nanosci. and Nanotech., 2003, 3, 81; O'Connell et al. Chem. Phys. Lett., 2001, 342, 265-271]. Such chemical functionalization of CNTs is generally divided into two types: tube end functionalization [see, e.g., Liu et al., Science, 1998, 280, 1253-1256; Chen et al., Science, 1998, 282, 95-98], and sidewall functionalization [see, e.g., PCT publication WO 02/060812 by Tour et al.; Khabashesku et al., Acc. Chem. Res., 2002, 35, 1087-1095; and Holzinger et al., Angew. Chem. Int. Ed., 2001, 40, 4002-4005], and can serve to facilitate the debundling and dissolution of such CNTs in various solvents. Scalable chemical strategies have been, and are being, developed to scale up such chemical manipulation [Ying et al., Org. Letters, 2003, 5, 1471-1473, Bahr et al., J. Am. Chem. Soc., 2001, 123, 6536-6542; and Kamaras et al., Science, 2003, 301, 1501].

The diameter and chirality of individual CNTs are described by integers “n” and “m,” where (n,m) is a vector along a graphene sheet which is conceptually rolled up to form a tube. When |n−m|=3q, where q is an integer, the CNT is a semi-metal (bandgaps on the order of milli eV). When n−m=0, the CNT is a true metal and referred to as an “armchair” nanotube. All other combinations of n−m are semiconducting CNTs with bandgaps typically in the range of 0.3 to 1.0 eV. See O'Connell et al., Science, 2002, 297, 593. CNT “type,” as used herein, refers to such electronic types described by the (n,m) vector (i.e., metallic, semi-metallic, and semiconducting). CNT “species,” as used herein, refers to CNTs with discrete (n,m) values. CNT “composition,” as used herein, refers to make up of a CNT population in terms of nanotube type and species.

All known preparative methods lead to polydisperse materials of semiconducting, semimetallic, and metallic electronic types. See M. S. Dresselhaus, G. Dresselhaus, P. C. Eklund, Science of Fullerenes and Carbon Nanotubes, Academic Press, San Diego, 1996; Bronikowski et al., Journal of Vacuum Science & Technology 2001, 19, 1800-1805; R. Saito, G. Dresselhaus, M. S. Dresselhaus, Physical Properties of Carbon Nanotubes, Imperial College Press, London, 1998. As such, a primary hurdle to the widespread application of CNTs, and SWNTs in particular, is their manipulation according to electronic structure [Avouris, Acc. Chem. Res. 2002, 35, 1026-1034]. Recently, however, methods to selectively functionalize CNTs based on their electronic structure (i.e., electronic type) have been reported [Strano et al., Science, 2003, 301, 1519-1522; commonly assigned co-pending International Patent Application PCT/US04/24507, filed Jul. 29, 2004]. In such reports, metallic CNTs are seen to react preferentially with diazonium species, permitting a separation or fractionation of metallic (including semimetallic) and semiconducting CNTs via partial functionalization of a mixture of metallic and semiconducting CNTs. Other methods with which CNTs can be separated by type have been reported. Such techniques include dielectrophoresis [Krupke et al., Science, 2003, 301, 244-347], selective precipitation [Chattophadhyay et al., J. Am. Chem. Soc., 2003, 125, 3370-3375], ion-exchange chromatography [Zheng et al., Nature Mater., 2003, 2, 338-342], and complexation/centrifugation [Chen et al., Nano Lett., 2003, 3, 1245-1249]. For a detailed discussion of CNT types and species, and their optical identification, see Bachilo et al., Science, 2002, 298, 2361-2366.

In light of the above-described advances in the manipulation and processing of CNTs, an efficient means of evaluating the composition of CNT populations, and particularly SWNT populations, in terms of their type and species, is clearly needed.

### BRIEF DESCRIPTION OF THE INVENTION

The present invention is directed toward methods and devices for analyzing populations of single-wall carbon nanotubes (SWNTs) on the basis of their fluorescence properties and a comparison of said fluorescence properties to fluorescence profiles of pre-determined SWNT compositions. Generally, such analyzing yields information about the composition of the SWNTs within said population. Such information includes, for example, the relative abundances of semiconducting SWNTs, the diameter distribution of such SWNTs, and the relative abundances of one or more particular SWNT species—as identified by one or more specific nanotube indices (n,m). The methods and devices of the present invention provide for the analysis of SWNT compositions in a rapid and efficient manner based on their fluorescence properties.

Generally, methods of the present invention comprise the steps of: (a) dispersing a sample in a solvent, wherein the sample comprises single-wall carbon nanotubes of undetermined composition, and wherein at least some of the single-wall carbon nanotubes are in a disaggregated state as a result of said dispersing; (b) irradiating the sample so as to effect fluorescence of the single-wall carbon nanotubes; (c) detecting and analyzing the fluorescence with an emission spectrometer; and (d) performing a compositional analysis on the sample by comparing the fluorescence of the sample to at least one database of pre-determined fluorescence profiles corresponding to specific sigle-wall carbon nanotube compositions and abundances so as to be determinative of the composition of the single-wall carbon nanotubes in the sample.

In some embodiments, such above-described methods further comprise a step of determining the sample's near-infrared absorption spectrum, wherein a comparison of emission and absorption spectra provide a measure of the extent of fluorescence quenching in the sample.

Generally, the devices of the present invention for analyzing SWNTs comprise: (a) at least one light source effective for inducing fluorescence in single-wall carbon nanotubes; (b) an emission spectrometer (e.g., a spectrograph or an interferometer-based device) effective for analyzing fluorescent emission in the near-infrared region of the electromagnetic spectrum; (c) a sample holder for a sample comprising single-wall carbon nanotubes of undetermined composition, wherein the sample holder permits the passage of light corresponding to excitation and emission wavelengths involved in fluorescence of the single-wall carbon nanotubes in the sample; and (d) a computer program for performing a compositional analysis of the sample based on a comparison of the fluorescence of the sample to database of pre-determined fluorescence profiles corresponding to specific single-wall carbon nanotube compositions and abundances so as to be determinative of the composition of the single-wall carbon nanotubes in the sample.

In some embodiments, such above-described devices further comprise a means for determining the sample's near-infrared absorption spectrum and comparing it to the sample's emission spectrum for the purpose of determining the extent of fluorescence quenching in the sample.

The methods and devices described herein are particularly directed to the analysis of SWNT populations, wherein such populations comprise semiconducting SWNTs that fluoresce. In some embodiments, information about metallic and semimetallic SWNTs present in a particular SWNT population can be inferred from the use of the above-described methods and devices, or they can be determined in combination with one or more additional techniques. While the methods and devices of the present invention are primarily directed to SWNT populations comprising SWNTs, they can generally be applied to any carbon nanotube (CNT) population with a component capable of undergoing fluorescence in accordance with the methods and devices of the present invention.

In some embodiments, the methods and/or devices of the present invention are used for the analysis of SWNTs in their as-produced state. In some or other embodiments, such methods and devices are useful for analyzing SWNT populations that have been manipulated in one or more ways (e.g., chemical derivatization, separation by type, purifications, etc.).

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and 1B depict, schematically, generalized devices for spectrofluorimetrically analyzing SWNT samples in accordance with embodiments of the present invention in both a 180° collection configuration (A) and a 90° collection configuration (B); and

FIG. 2 depicts, schematically, a typical device for spectrofluorimetrically analyzing SWNT samples in accordance with embodiments of the present invention.

### DESCRIPTION OF THE INVENTION

The present invention is directed toward methods and devices for analyzing populations of single-wall carbon nanotubes (SWNTs) on the basis of their fluorescence properties and a comparison of said fluorescence properties to fluorescence profiles of pre-determined SWNT compositions. Generally, such analyzing yields information about the composition of the SWNTs within said population. Such information includes, for example, the relative abundances of semiconducting SWNTs, the diameter distribution of such SWNTs, and the relative abundances of one or more particular SWNT species—as identified by one or more specific nanotube indices (n,m). The methods and devices of the present invention provide for the analysis of SWNT compositions in a rapid and efficient manner.

The present invention exploits knowledge about the spectroscopic properties of SWNTs to provide specialized methods and apparatus for efficient fluorimetric analysis of bulk SWNT samples. In some embodiments, such analysis is predicated on a recognition that visible light, at a single well-chosen wavelength, can induce near-infrared fluorescence emission from a wide variety of distinct semiconducting SWNT species. Thus, by using a detector that registers all of these characteristic emission wavelengths in parallel, an information-rich emission spectrum can be acquired from a bulk sample in approximately one second. The spectrum can then be rapidly computer-simulated as a combination of peaks from specific nanotube species whose spectral signatures are known from prior spectroscopic research. By combining this data reduction approach with a customized apparatus, rapid compositional analyses of bulk SWNT samples can be achieved.

Bulk SWNT samples are heterogeneous because they contain a variety of different SWNT structures (species), each with a specific diameter and chiral angle. The practical analysis of such samples remains a significant challenge. This invention provides a means to determine the presence and relative abundances of various semiconducting nanotube species present in a sample, and/or the distribution of nanotube diameters within the sample. Such analyses would be valuable to research labs, to nanotube producers for process optimization and quality control, and to industrial nanotube users to certify the composition of incoming materials.

Fluorimetric nanotube analysis provides a more complete assay of the semiconducting single-walled carbon nanotubes in a bulk sample as compared to other methods such as Raman spectroscopy. Generally, spectrofluorimeters used in embodiments of the present invention are specifically designed for SWNT analysis such that they provide improved simplicity, compactness, speed, and automation, compared to a general purpose spectrofluorimetry instrument that might be used for SWNT analysis.

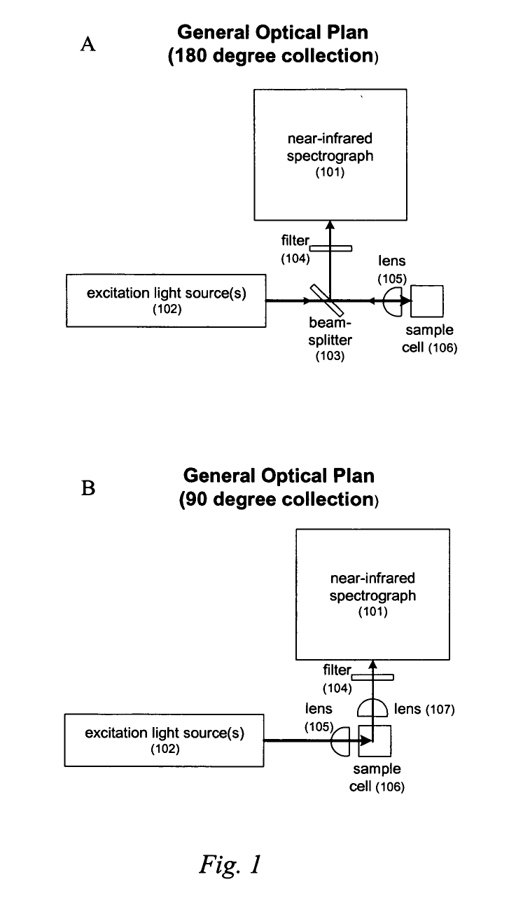

Referring to FIGS. 1A and 1B, in some embodiments, devices of the present invention can comprise one or multiple light sources 102 that are used to irradiate a SWNT sample, located in a sample cell 106, with appropriate excitation wavelength(s) in the visible or near-ultraviolet regions of the optical spectrum. These light sources 102 may be lasers or spectrally filtered incoherent emitters. The near-infrared fluorescent luminescence induced from the sample is partially collected by a suitable lens system (lenses 105 and 107, filter 104, and bean-splitter 103) and directed into a spectrograph 101 that has a diffraction grating and multichannel detector appropriate for registering the nanotube emission spectrum. The emission may be collected at 180 degrees to the excitation direction with the use of an appropriate beamsplitter (FIG. 1A), or, alternatively, at other angles such as 90 degrees without the use of a beamsplitter (FIG. 1B).

In some embodiments, the SWNT sample's absorption spectrum is also measured. To do so, the excitation sources are switched off or blocked, and light from an incandescent lamp is directed through the sample cell into the detection system used for emission measurements. Comparison of the transmitted near-infrared spectra taken with the sample and with a SWNT-free reference cell provides the nanotube sample's absorption spectrum.

In some embodiments of the present invention, a solid SWNT sample is ultrasonically dispersed in a D₂O or H₂O solution of a surfactant such as sodium dodecylsulfate (SDS) or sodium dodecyl benzene sulfonate (SDBS). The resulting suspension is then transferred to a spectrofluorimetric cuvette. When the sample cuvette is placed into the fluorimetric analyzer, it is irradiated with light at wavelengths capable of inducing near-infrared fluorescent emission from disaggregated semiconducting SWNT in the sample. This emission is collected, directed into a spectrograph, and measured with a multichannel detector array. Then the excitation light source is blocked and the sample is illuminated with a broadband light source in the near-infrared. Transmission of this light through the cuvette is measured by the spectrograph and detector array to obtain the sample's near-infrared absorption spectrum. Both emission and absorption spectra are automatically transferred to a computer and evaluated to determine the SWNT species giving the fluorescent emission, their relative abundances, and the approximate fraction of absorbing species that fluoresce. This compositional analysis is based on prior assignments of optical transitions to various SWNT species, designated by (n,m). See Bachilo et al., Science, 2002, 298, 2361-2366; and Weisman et al., Nano Lett., 2003, 3, 1235-1238. The compositional analysis is presented in the form of an index of the sample's fluorescent quality, an inventory of specific nanotube structures and abundances, and/or as a distribution of nanotube diameters and chiral angles.

Variations of the present invention include use as a reader of SWNT-ink spectral bar codes (see commonly assigned, co-pending International Application Serial No. PCT/US 04/28603, filed Sep. 2, 2004) and as an efficient detector of SWNT in environmental or biological environments. The present invention can also be integrated with an HPLC detector to provide real-time analyses of the SWNT compositions of eluted chromatographic fractions. This latter embodiment could be valuable in current efforts to chromatographically separate nanotube mixtures by diameter.

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### EXAMPLE 1

This example serves to illustrate a specific device configuration useful in the compositional analysis of SWNT samples, according to one or more embodiments of the present invention.

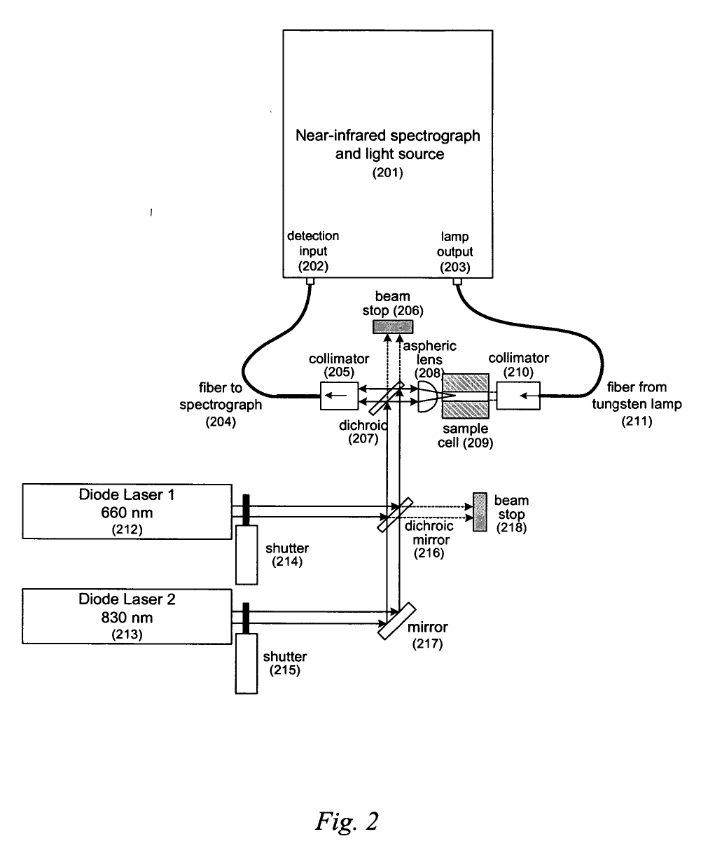

Two excitation sources irradiate the sample sequentially, with their beams controlled by automated optical shutters. Referring to FIG. 2, these sources are diode lasers 212 and 213 emitting at approximately 660 and 830 nm, respectively. Appropriate dichroic mirrors 216 and 207 reflect the excitation beams into a rectangular sample cell through an aspheric lens 208 of focal length approximately 5 mm. This lens also collects and collimates some of the fluorescence light from the nanotube sample and directs it through a near-infrared transmitting dichroic mirror 207. The fluorescence light is then focused into a multi-mode fiber optic 204 by a collimating lens 205. The fiber optic leads to the entrance slit (detection input 202) of a near-infrared grating spectrograph 201 that has a multichannel InGaAs detector array at its exit plane. The signals from this detector array thereby reveal the nanotube sample's fluorescence emission spectrum for excitation by either of the diode lasers.

To perform absorption spectrometry, light from a tungsten lamp emanates from lamp output 203 and is directed into a fiber optic 211 and then through a sample cell 209, where it is partially captured by the detection optics and spectrograph 201. The spectrum of this light is measured through a reference cell (containing aqueous surfactant but no SWNT) and again with the SWNT sample cell. At each wavelength, intensities from the two spectra are divided, and the logarithm of that ratio provides the sample's near-infrared absorbance spectrum. Comparison of the emission and absorbance spectra for a sample provides a measure of the extent of fluorescence quenching in the sample through processes such as chemical damage or nanotube aggregation.

### EXAMPLE 2

This example serves to illustrate a manner in which a SWNT sample can be analyzed by the device described in Example 1.

A small solid sample (<1 mg) of raw SWNTs is quickly dispersed in about 10 ml of an aqueous detergent solution using a microprobe-type ultrasonic homogenizer. The resulting sample typically contains many bundled SWNTs plus some individual SWNTs. Although the bundled species will not fluoresce significantly, the unbundled ones will fluoresce strongly enough to permit rapid fluorimetric analysis of the sample. Typically less than 1 ml of sample is transferred to a standard optical cuvette. Referring again to FIG. 2, light from a diode laser 212 (typically ca. 660 nm) is reflected from specialized dichroic mirrors 207 and 216 and focused into the sample cell 209 by an aspherical short focal length lens 208 (ca. 4 mm) to optically excite the nanotubes. A portion of the resulting near-infrared fluorescence is captured by the same lens 208 and directed back toward the dichroic mirror 207 through which it is transmitted. Using collimator 205, this light is then focused into the end of a multimode optical fiber 204 chosen for high transmittance in the near-infrared. The fiber delivers the fluorescence light to the input 202 of a spectrograph/InGaAs photodiode array 201 designed to disperse and detect light in the wavelength range typical of SWNT emission. A control computer records this emission spectrum. The excitation light is then blocked and a broadband near-infrared light source is directed through the sample cuvette toward the optical fiber. The spectrograph/detector thereby acquires the absorption spectrum of the sample and sends the data to the control computer.

The fluorescence spectrum, which contains numerous features corresponding to the variety of SWNT species present in the sample, is computer-analyzed by a nonlinear least-squares process as a superposition of Voigt profiles having specific center frequencies previously found from studies of SWNT spectroscopic properties. The spectral components deduced from the fitting process reveal the presence of the corresponding (n,m) semiconducting SWNT in the sample. The amplitudes of these components, after correction by appropriate sensitivity factors that depend on the excitation wavelength and the specific (n,m) species, reveal the relative abundances of these species in the sample. Optionally, a second laser wavelength can also be used to induce fluorescence, and a comparison of the two emission spectra provides additional information about the (n,m) composition. Finally, a quantitative comparison of the emission and absorption strengths indicates the proportion of fluorescent SWNT in the sample. This value may be interpreted as a figure of merit for the fraction of undamaged, individual SWNT suspended in the sample.

### EXAMPLE 3

This example serves to illustrate a manner in which the computational analysis of the spectral profiles of the SWNT samples can be accomplished.

The raw emission spectrum (obtained from a device such as that shown in FIG. 2) is transmitted to a controlling computer and then analyzed using custom-written software routines. In this process, the intensities are first corrected for wavelength-dependent variations in the instrument's sensitivity, using a pre-determined response function. The corrected spectrum is transformed from a wavelength scale to an optical frequency scale. Using tabulated, pre-calculated emission profiles for a wide range of nanotube species (see Table 1), the corrected and transformed emission spectrum is simulated (in an iterative nonlinear least-squares fitting process) as a superposition of such profiles. The simulation result gives a set of amplitudes for the various nanotube species. These amplitudes are then multiplied by predetermined sensitivity factors to correct for the variations in excitation efficiency of different species at the relevant excitation wavelength. The corrected species amplitudes are displayed as a table of apparent relative concentrations for the range of nanotube species present in the sample. They may also be further adjusted using species-dependent photophysical efficiency factors. Finally, the results are used to compute and display the distribution of nanotube diameters and/or chiral angles present in the sample.

TABLE 1
Structures and first- and second-van Hove optical transitions for
semiconducting SWNT structures with diameters between 0.48 and
2.0 nm. See Weisman et al., Nano Lett., 2003, 3, 1235-1238.

| (n, m) | dₜ(nm) | α(deg) | mod^{a} | λ₁₁(nm) | ν₁₁(cm⁻¹) | E₁₁(eV)^{b} | λ₂₂(nm) | ν₂₂(cm⁻¹) | E₂₂(eV) |
|---|---|---|---|---|---|---|---|---|---|
| (4, 3) | 0.483 | 25.28 | 1 | 700 | 14,283 | 1.771 | 398 | 25,147 | 3.118 |
| (5, 3) | 0.556 | 21.79 | 2 | 720 | 13,884 | 1.721 | 522 | 19,147 | 2.374 |
| (5, 4) | 0.620 | 26.33 | 1 | 835 | 11,974 | 1.485 | 483 | 20,697 | 2.566 |
| (6, 1) | 0.521 | 7.59 | 2 | 653 | 15,323 | 1.900 | 632 | 15,828 | 1.962 |
| (6, 2) | 0.572 | 13.90 | 1 | 894 | 11,183 | 1.387 | 418 | 23,900 | 2.963 |
| (6, 4) | 0.692 | 23.41 | 2 | 873 | 11,452 | 1.420 | 578 | 17,312 | 2.146 |
| (6, 5) | 0.757 | 27.00 | 1 | 976 | 10,244 | 1.270 | 566 | 17,667 | 2.190 |
| (7, 0) | 0.556 | 0.00 | 1 | 962 | 10,397 | 1.289 | 395 | 25,318 | 3.139 |
| (7, 2) | 0.650 | 12.22 | 2 | 802 | 12,468 | 1.546 | 626 | 15,977 | 1.981 |
| (7, 3) | 0.706 | 17.00 | 1 | 992 | 10,083 | 1.250 | 505 | 19,820 | 2.457 |
| (7, 5) | 0.829 | 24.50 | 2 | 1,024 | 9,768 | 1.211 | 645 | 15,496 | 1.921 |
| (7, 6) | 0.895 | 27.46 | 1 | 1,120 | 8,930 | 1.107 | 648 | 15,441 | 1.914 |
| (8, 0) | 0.635 | 0.00 | 2 | 776 | 12,886 | 1.598 | 660 | 15,146 | 1.878 |
| (8, 1) | 0.678 | 5.82 | 1 | 1,041 | 9,603 | 1.191 | 471 | 21,226 | 2.632 |
| (8, 3) | 0.782 | 15.30 | 2 | 952 | 10,508 | 1.303 | 665 | 15,029 | 1.863 |
| (8, 4) | 0.840 | 19.11 | 1 | 1,111 | 8,997 | 1.116 | 589 | 16,981 | 2.105 |
| (8, 6) | 0.966 | 25.28 | 2 | 1,173 | 8,525 | 1.057 | 718 | 13,928 | 1.727 |
| (8, 7) | 1.032 | 27.80 | 1 | 1,265 | 7,908 | 0.981 | 728 | 13,727 | 1.702 |
| (9, 1) | 0.757 | 5.21 | 2 | 912 | 10,964 | 1.359 | 691 | 14,466 | 1.794 |
| (9, 2) | 0.806 | 9.83 | 1 | 1,138 | 8,790 | 1.090 | 551 | 18,155 | 2.251 |
| (9, 4) | 0.916 | 17.48 | 2 | 1,101 | 9,086 | 1.126 | 722 | 13,843 | 1.716 |
| (9, 5) | 0.976 | 20.63 | 1 | 1,241 | 8,055 | 0.999 | 672 | 14,883 | 1.845 |
| (9, 7) | 1.103 | 25.87 | 2 | 1,322 | 7,567 | 0.938 | 793 | 12,610 | 1.563 |
| (9, 8) | 1.170 | 28.05 | 1 | 1,410 | 7,093 | 0.879 | 809 | 12,362 | 1.533 |
| (10, 0) | 0.794 | 0.00 | 1 | 1,156 | 8,652 | 1.073 | 537 | 18,606 | 2.307 |
| (10, 2) | 0.884 | 8.95 | 2 | 1,053 | 9,493 | 1.177 | 737 | 13,574 | 1.683 |
| (10, 3) | 0.936 | 12.73 | 1 | 1,249 | 8,006 | 0.993 | 632 | 15,834 | 1.963 |
| (10, 5) | 1.050 | 19.11 | 2 | 1,249 | 8,006 | 0.993 | 788 | 12,695 | 1.574 |
| (10, 6) | 1.111 | 21.79 | 1 | 1,377 | 7,262 | 0.900 | 754 | 13,262 | 1.644 |
| (10, 8) | 1.240 | 26.33 | 2 | 1,470 | 6,805 | 0.844 | 869 | 11,502 | 1.426 |
| (10, 9) | 1.307 | 28.26 | 1 | 1,556 | 6,428 | 0.797 | 889 | 11,248 | 1.395 |
| (11, 0) | 0.873 | 0.00 | 2 | 1,037 | 9,644 | 1.196 | 745 | 13,431 | 1.665 |
| (11, 1) | 0.916 | 4.31 | 1 | 1,265 | 7,906 | 0.980 | 610 | 16,388 | 2.032 |
| (11, 3) | 1.014 | 11.74 | 2 | 1,197 | 8,353 | 1.036 | 793 | 12,617 | 1.564 |
| (11, 4) | 1.068 | 14.92 | 1 | 1,371 | 7,295 | 0.904 | 712 | 14,036 | 1.740 |
| (11, 6) | 1.186 | 20.36 | 2 | 1,397 | 7,157 | 0.887 | 858 | 11,661 | 1.446 |
| (11, 7) | 1.248 | 22.69 | 1 | 1,516 | 6,597 | 0.818 | 836 | 11,968 | 1.484 |
| (11, 9) | 1.377 | 26.70 | 2 | 1,617 | 6,183 | 0.767 | 947 | 10,564 | 1.310 |
| (11, 10) | 1.444 | 28.43 | 1 | 1,702 | 5,877 | 0.729 | 969 | 10,320 | 1.280 |
| (12, 1) | 0.995 | 3.96 | 2 | 1,170 | 8,549 | 1.060 | 799 | 12,516 | 1.552 |
| (12, 2) | 1.041 | 7.59 | 1 | 1,378 | 7,255 | 0.900 | 686 | 14,575 | 1.807 |
| (12, 4) | 1.145 | 13.90 | 2 | 1,342 | 7,452 | 0.924 | 855 | 11,693 | 1.450 |
| (12, 5) | 1.201 | 16.63 | 1 | 1,499 | 6,670 | 0.827 | 793 | 12,605 | 1.563 |
| (12, 7) | 1.321 | 21.36 | 2 | 1,545 | 6,473 | 0.803 | 930 | 10,751 | 1.333 |
| (12, 8) | 1.384 | 23.41 | 1 | 1,657 | 6,036 | 0.748 | 917 | 10,910 | 1.353 |
| (12, 10) | 1.515 | 27.00 | 2 | 1,765 | 5,666 | 0.703 | 1,024 | 9,763 | 1.210 |
| (12, 11) | 1.582 | 28.56 | 1 | 1,848 | 5,412 | 0.671 | 1,049 | 9,535 | 1.182 |
| (13, 0) | 1.032 | 0.00 | 1 | 1,384 | 7,228 | 0.896 | 677 | 14,770 | 1.831 |
| (13, 2) | 1.120 | 7.05 | 2 | 1,307 | 7,651 | 0.949 | 858 | 11,661 | 1.446 |
| (13, 3) | 1.170 | 10.16 | 1 | 1,498 | 6,676 | 0.828 | 764 | 13,095 | 1.624 |
| (13, 5) | 1.278 | 15.61 | 2 | 1,487 | 6,723 | 0.834 | 922 | 10,843 | 1.344 |
| (13, 6) | 1.336 | 17.99 | 1 | 1,632 | 6,127 | 0.760 | 874 | 11,441 | 1.419 |
| (13, 8) | 1.457 | 22.17 | 2 | 1,692 | 5,909 | 0.733 | 1,004 | 9,956 | 1.234 |
| (13, 9) | 1.521 | 24.01 | 1 | 1,799 | 5,558 | 0.689 | 997 | 10,027 | 1.243 |
| (13, 11) | 1.652 | 27.25 | 2 | 1,912 | 5,230 | 0.648 | 1,102 | 9,071 | 1.125 |
| (13, 12) | 1.719 | 28.68 | 1 | 1,994 | 5,015 | 0.622 | 1,128 | 8,862 | 1.099 |
| (14, 0) | 1.111 | 0.00 | 2 | 1,295 | 7,721 | 0.957 | 859 | 11,640 | 1.443 |
| (14, 1) | 1.153 | 3.42 | 1 | 1,502 | 6,660 | 0.826 | 748 | 13,364 | 1.657 |
| (14, 3) | 1.248 | 9.52 | 2 | 1,447 | 6,910 | 0.857 | 920 | 10,867 | 1.347 |
| (14, 4) | 1.300 | 12.22 | 1 | 1,623 | 6,162 | 0.764 | 842 | 11,875 | 1.472 |
| (14, 6) | 1.411 | 17.00 | 2 | 1,633 | 6,123 | 0.759 | 992 | 10,078 | 1.250 |
| (14, 7) | 1.470 | 19.11 | 1 | 1,768 | 5,655 | 0.701 | 955 | 10,476 | 1.299 |
| (14, 9) | 1.594 | 22.85 | 2 | 1,840 | 5,435 | 0.674 | 1,080 | 9,261 | 1.148 |
| (14, 10) | 1.658 | 24.50 | 1 | 1,942 | 5,148 | 0.638 | 1,078 | 9,279 | 1.150 |
| (14, 12) | 1.789 | 27.46 | 2 | 2,059 | 4,856 | 0.602 | 1,181 | 8,470 | 1.050 |
| (14, 13) | 1.857 | 28.78 | 1 | 2,141 | 4,672 | 0.579 | 1,208 | 8,278 | 1.026 |
| (15, 1) | 1.232 | 3.20 | 2 | 1,426 | 7,011 | 0.869 | 920 | 10,864 | 1.347 |
| (15, 2) | 1.278 | 6.18 | 1 | 1,622 | 6,165 | 0.764 | 822 | 12,163 | 1.508 |
| (15, 4) | 1.377 | 11.52 | 2 | 1,589 | 6,294 | 0.780 | 986 | 10,140 | 1.257 |
| (15, 5) | 1.431 | 13.90 | 1 | 1,752 | 5,708 | 0.708 | 921 | 10,858 | 1.346 |
| (15, 7) | 1.546 | 18.14 | 2 | 1,779 | 5,621 | 0.697 | 1,064 | 9,396 | 1.165 |
| (15, 8) | 1.606 | 20.03 | 1 | 1,907 | 5,245 | 0.650 | 1,035 | 9,663 | 1.198 |
| (15, 10) | 1.730 | 23.41 | 2 | 1,987 | 5,032 | 0.624 | 1,156 | 8,650 | 1.072 |
| (15, 11) | 1.795 | 24.92 | 1 | 2,086 | 4,793 | 0.594 | 1,158 | 8,635 | 1.071 |
| (15, 13) | 1.927 | 27.64 | 2 | 2,207 | 4,532 | 0.562 | 1,259 | 7,942 | 0.985 |
| (15, 14) | 1.994 | 28.86 | 1 | 2,287 | 4,373 | 0.542 | 1,288 | 7,767 | 0.963 |
| (16, 0) | 1.270 | 0.00 | 1 | 1,623 | 6,163 | 0.764 | 815 | 12,264 | 1.521 |
| (16, 2) | 1.357 | 5.82 | 2 | 1,561 | 6,405 | 0.794 | 984 | 10,162 | 1.260 |
| (16, 3) | 1.405 | 8.44 | 1 | 1,746 | 5,728 | 0.710 | 898 | 11,139 | 1.381 |
| (16, 5) | 1.508 | 13.17 | 2 | 1,732 | 5,775 | 0.716 | 1,055 | 9,480 | 1.175 |
| (16, 6) | 1.564 | 15.30 | 1 | 1,884 | 5,307 | 0.658 | 1,000 | 9,999 | 1.240 |
| (16, 8) | 1.680 | 19.11 | 2 | 1,925 | 5,194 | 0.644 | 1,138 | 8,788 | 1.090 |
| (16, 9) | 1.741 | 20.82 | 1 | 2,046 | 4,887 | 0.606 | 1,115 | 8,968 | 1.112 |
| (16, 11) | 1.867 | 23.90 | 2 | 2,134 | 4,685 | 0.581 | 1,233 | 8,111 | 1.006 |
| (16, 12) | 1.932 | 25.28 | 1 | 2,231 | 4,483 | 0.556 | 1,238 | 8,077 | 1.001 |
| (17, 0) | 1.350 | 0.00 | 2 | 1,552 | 6,443 | 0.799 | 984 | 10,167 | 1.261 |
| (17, 1) | 1.391 | 2.83 | 1 | 1,744 | 5,733 | 0.711 | 886 | 11,289 | 1.400 |
| (17, 3) | 1.483 | 7.99 | 2 | 1,699 | 5,886 | 0.730 | 1,050 | 9,525 | 1.181 |
| (17, 4) | 1.533 | 10.33 | 1 | 1,873 | 5,340 | 0.662 | 974 | 10,263 | 1.272 |
| (17, 6) | 1.641 | 14.56 | 2 | 1,875 | 5,332 | 0.661 | 1,125 | 8,886 | 1.102 |
| (17, 7) | 1.697 | 16.47 | 1 | 2,019 | 4,952 | 0.614 | 1,079 | 9,264 | 1.149 |
| (17, 9) | 1.816 | 19.93 | 2 | 2,072 | 4,827 | 0.599 | 1,212 | 8,248 | 1.023 |
| (17, 10) | 1.877 | 21.49 | 1 | 2,188 | 4,571 | 0.567 | 1,195 | 8,367 | 1.037 |
| (18, 1) | 1.470 | 2.68 | 2 | 1,682 | 5,944 | 0.737 | 1,048 | 9,543 | 1.183 |
| (18, 2) | 1.515 | 5.21 | 1 | 1,868 | 5,353 | 0.664 | 958 | 10,433 | 1.294 |
| (18, 4) | 1.611 | 9.83 | 2 | 1,838 | 5,439 | 0.674 | 1,118 | 8,947 | 1.109 |
| (18, 5) | 1.663 | 11.93 | 1 | 2,003 | 4,993 | 0.619 | 1,052 | 9,508 | 1.179 |
| (18, 7) | 1.773 | 15.75 | 2 | 2,020 | 4,952 | 0.614 | 1,197 | 8,351 | 1.035 |
| (18, 8) | 1.831 | 17.48 | 1 | 2,156 | 4,638 | 0.575 | 1,159 | 8,629 | 1.070 |
| (18, 10) | 1.951 | 20.63 | 2 | 2,218 | 4,509 | 0.559 | 1,288 | 7,765 | 0.963 |
| (19, 0) | 1.508 | 0.00 | 1 | 1,867 | 5,357 | 0.664 | 953 | 10,492 | 1.301 |
| (19, 2) | 1.594 | 4.95 | 2 | 1,816 | 5,507 | 0.683 | 1,114 | 8,979 | 1.113 |
| (19, 3) | 1.641 | 7.22 | 1 | 1,994 | 5,015 | 0.622 | 1,033 | 9,683 | 1.201 |
| (19, 5) | 1.741 | 11.39 | 2 | 1,979 | 5,052 | 0.626 | 1,187 | 8,422 | 1.044 |
| (19, 6) | 1.795 | 13.29 | 1 | 2,135 | 4,684 | 0.581 | 1,130 | 8,853 | 1.098 |
| (19, 8) | 1.907 | 16.76 | 2 | 2,164 | 4,621 | 0.573 | 1,271 | 7,869 | 0.976 |
| (19, 9) | 1.966 | 18.35 | 1 | 2,295 | 4,358 | 0.540 | 1,238 | 8,076 | 1.001 |
| (20, 0) | 1.588 | 0.00 | 2 | 1,808 | 5,531 | 0.686 | 1,113 | 8,989 | 1.114 |
| (20, 1) | 1.629 | 2.42 | 1 | 1,990 | 5,024 | 0.623 | 1,023 | 9,775 | 1.212 |
| (20, 3) | 1.719 | 6.89 | 2 | 1,952 | 5,124 | 0.635 | 1,181 | 8,466 | 1.050 |
| (20, 4) | 1.768 | 8.95 | 1 | 2,122 | 4,712 | 0.584 | 1,108 | 9,025 | 1.119 |
| (20, 6) | 1.872 | 12.73 | 2 | 2,121 | 4,715 | 0.585 | 1,258 | 7,947 | 0.985 |
| (20, 7) | 1.927 | 14.46 | 1 | 2,269 | 4,406 | 0.546 | 1,208 | 8,280 | 1.027 |
| (21, 1) | 1.708 | 2.31 | 2 | 1,938 | 5,161 | 0.640 | 1,178 | 8,487 | 1.052 |
| (21, 2) | 1.752 | 4.50 | 1 | 2,116 | 4,727 | 0.586 | 1,095 | 9,134 | 1.132 |
| (21, 4) | 1.847 | 8.57 | 2 | 2,090 | 4,786 | 0.593 | 1,250 | 8,000 | 0.992 |
| (21, 5) | 1.897 | 10.44 | 1 | 2,253 | 4,439 | 0.550 | 1,184 | 8,445 | 1.047 |
| (22, 0) | 1.747 | 0.00 | 1 | 2,114 | 4,731 | 0.587 | 1,090 | 9,171 | 1.137 |
| (22, 2) | 1.831 | 4.31 | 2 | 2,070 | 4,830 | 0.599 | 1,245 | 8,030 | 0.996 |
| (22, 3) | 1.877 | 6.31 | 1 | 2,243 | 4,459 | 0.553 | 1,168 | 8,560 | 1.061 |
| (22, 5) | 1.975 | 10.02 | 2 | 2,229 | 4,487 | 0.556 | 1,320 | 7,575 | 0.939 |
| (23, 0) | 1.826 | 0.00 | 2 | 2,064 | 4,845 | 0.601 | 1,244 | 8,039 | 0.997 |
| (23, 1) | 1.867 | 2.11 | 1 | 2,238 | 4,467 | 0.554 | 1,160 | 8,620 | 1.069 |
| (23, 3) | 1.956 | 6.05 | 2 | 2,205 | 4,535 | 0.562 | 1,314 | 7,612 | 0.944 |
| (24, 1) | 1.946 | 2.02 | 2 | 2,193 | 4,560 | 0.565 | 1,311 | 7,631 | 0.946 |
| (24, 2) | 1.990 | 3.96 | 1 | 2,365 | 4,229 | 0.524 | 1,231 | 8,121 | 1.007 |
| (25, 0) | 1.985 | 0.00 | 1 | 2,362 | 4,233 | 0.525 | 1,228 | 8,146 | 1.010 |

^{a}the value of mod(n-m, 3)
^{b}E₁₁ values represent emission peaks; to obtain absorption peak energies, add ca. 0.004 eV

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A fluorimetric analyzer for single-wall carbon nanotubes comprising:
a) at least one light source effective for inducing fluorescence in single-wall carbon nanotubes;
b) an emission spectrometer effective for analyzing fluorescent emission in the near-infrared region of the electromagnetic spectrum;
c) a sample holder comprising a sample, the sample comprising single-wall carbon nanotubes of undetermined composition, wherein the sample holder permits the passage of light corresponding to excitation and emission wavelengths involved in fluorescence of the single-wall carbon nanotubes in the sample; and
d) a computer program for performing a compositional analysis of the sample based on a comparison of the fluorescence of the sample to a database of pre-determined fluorescence profiles corresponding to specific single-wall carbon nanotube compositions and abundances so as to be determinative of the composition of the single-wall carbon nanotubes in the sample.

2. The fluorimetric analyzer of claim 1, wherein the at least one light source provides excitation in a region of the electromagnetic spectrum selected from the group consisting of visible, near-ultraviolet, and combinations thereof.

3. The fluorimetric analyzer of claim 1, wherein the at least one light source is selected from the group consisting of lasers, spectrally-filtered incoherent emitters, and combinations thereof.

4. The fluorimetric analyzer of claim 1, wherein the emission spectrometer is selected from the group consisting of a spectrograph and an interferometer-based device.

5. The fluorimetric analyzer of claim 1, wherein the emission spectrometer is a spectrograph comprising a diffraction grating and a detector, and wherein the detector is a multichannel detector suitable for registering the single-wall carbon nanotube emission spectrum.

6. The fluorimetric analyzer of claim 1, wherein the sample holder is a spectrofluorimetric cuvette.

7. The fluorimetric analyzer of claim 1 further comprising a suitable lens system for directing excitation and emission radiation into and out of the sample holder and into the emission spectrometer.

8. The fluorimetric analyzer of claim 1, wherein the compositional analysis yields an index for the sample, said index comprising information selected from the group consisting of fluorescent quality, an inventory of specific nanotube structures and abundances, a distribution of nanotube diameters and chiral angles, and combinations thereof.

9. The fluorimetric analyzer of claim 1, wherein the sample comprises single-wall carbon nanotubes that are dispersed in an aqueous solution comprising a surfactant.

10. The fluorimetric analyzer of claim 1, wherein the sample comprises single-wall carbon nanotubes that are in a disaggregated state.

11. The fluorimetric analyzer of claim 1, wherein the sample is a single-wall carbon nanotube ink.

12. A fluorimetric analyzer for single-wall carbon nanotubes comprising:
a) a means for inducing fluorescence in a sample comprising single-wall carbon nanotubes of unknown composition;
b) a means for detecting and analyzing fluorescence in the sample;
c) a means for holding the sample such that the single-wall carbon nanotubes can be induced to fluorescence, and such that the fluorescence can be detected and analyzed; and
d) a means for performing a compositional analysis of the single-wall carbon nanotubes within the sample based on a comparison of the fluorescence profile of the sample to a database of pre-determined fluorescence profiles corresponding to specific single-wall carbon nanotube compositions and abundances.

13. The fluorimetric analyzer of claim 12, wherein the means for inducing fluorescence provides excitation in a region of the electromagnetic spectrum selected from the group consisting of visible, near-ultraviolet, and combinations thereof.

14. The fluorimetric analyzer of claim 12, wherein the means for inducing fluorescence comprises at least one light source selected from the group consisting of lasers, spectrally-filtered incoherent emitters, and combinations thereof.

15. The fluorimetric analyzer of claim 12, wherein the means for detecting and analyzing fluorescence comprises a spectrograph, the spectrograph comprising a diffraction grating and a detector.

16. The fluorimetric analyzer of claim 15, wherein the detector is a multichannel detector suitable for registering the single-wall carbon nanotube emission spectrum.

17. The fluorimetric analyzer of claim 12, wherein the means for holding the sample comprises a spectrofluorimetric cuvette.

18. The fluorimetric analyzer of claim 12 further comprising a means for directing excitation and emission radiation into and out of the sample holder and into the spectrograph, said means comprising at least one device selected from the group consisting of a lens, a mirror, a beam splitter, a dichroic mirror, a collimator, an optical fiber, a collimator, a beam stop, and combinations and multiples thereof.

19. The fluorimetric analyzer of claim 12, wherein the means for performing the compositional analysis comprises a computer and a computer program, and wherein said compositional analysis yields an index for the sample, said index comprising information selected from the group consisting of fluorescent quality, an inventory of specific nanotube structures and abundances, a distribution of nanotube diameters and chiral angles, and combinations thereof.

20. The fluorimetric analyzer of claim 12, wherein the sample comprises single-wall carbon nanotubes that are dispersed in an aqueous solution comprising a surfactant.

21. The fluorimetric analyzer of claim 12, wherein the sample comprises single-wall carbon nanotubes that are in a disaggregated state.

22. The fluorimetric analyzer of claim 12 further comprising a means of determining the sample's near-infrared absorption spectrum.

23. The fluorimetric analyzer of claim 22, wherein a comparison of emission and absorption spectra provide a measure of the extent of fluorescence quenching in the sample.

24. The fluorimetric analyzer of claim 12, wherein the sample is single-wall carbon nanotube ink.

25. A method comprising the steps of:
a) dispersing a sample in a solvent, wherein the sample comprises single-wall carbon nanotubes of undetermined composition, and wherein at least some of the single-wall carbon nanotubes are in a disaggregated state as a result of said dispersing;
b) irradiating the sample so as to effect fluorescence of the single-wall carbon nanotubes;
c) detecting and analyzing the fluorescence with an emission spectrometer; and
d) performing a compositional analysis on the sample by comparing the fluorescence of the sample to database of pre-determined fluorescence profiles corresponding to specific single-wall carbon nanotube compositions and abundances so as to be determinative of the composition of the single-wall carbon nanotubes in the sample.

26. The method of claim 25, wherein the solvent is aqueous.

27. The method of claim 26, wherein the solvent further comprises a surfactant to facilitate dispersing the sample and disaggregating at least some of the single-wall carbon nanotubes.

28. The method of claim 25, wherein the emission spectrometer is a spectrograph comprising a diffraction grating and a multichannel detector.

29. The method of claim 25, wherein the step of performing a compositional analysis on the sample is done with a computer.

30. The method of claim 25 further comprising a step of determining the sample's near-infrared absorption spectrum.

31. The method of claim 30, wherein a comparison of emission and absorption spectra provide a measure of the extent of fluorescence quenching in the sample.

32. A fluorimetric analyzer for single-wall carbon nanotubes comprising:
a) at least one light source effective for inducing fluorescence in single-wall carbon nanotubes;
b) an emission spectrometer effective for analyzing fluorescent emission in the near-infrared region of the electromagnetic spectrum;
c) a sample holder for holding a sample comprising single-wall carbon nanotubes of undetermined composition, wherein the sample holder permits the passage of light corresponding to excitation and emission wavelengths involved in fluorescence of the single-wall carbon nanotubes in the sample; and
d) a computer program for performing a compositional analysis of the sample based on a comparison of the fluorescence of the sample to database of pre-determined fluorescence profiles corresponding to specific single-wall carbon nanotube compositions and abundances so as to be determinative of the composition of the single-wall carbon nanotubes in the sample.

33. The fluorimetric analyzer of claim 32, wherein the at least one light source provides excitation in a region of the electromagnetic spectrum selected from the group consisting of visible, near-ultraviolet, and combinations thereof.

34. The fluorimetric analyzer of claim 32, wherein the at least one light source is selected from the group consisting of lasers, spectrally-filtered incoherent emitters, and combinations thereof

35. The fluorimetric analyzer of claim 32, wherein the emission spectrometer is selected from the group consisting of a spectrograph and an interferometer-based device.

36. The fluorimetric analyzer of claim 32, wherein the emission spectrometer is a spectrograph comprising a diffraction grating and a detector, and wherein the detector is a multichannel detector suitable for registering the emission wavelengths of fluorescing single-wall carbon nanotubes.

37. The fluorimetric analyzer of claim 32, wherein the sample holder is a spectrofluorimetric cuvette.

38. The fluorimetric analyzer of claim 32 further comprising a suitable lens system for directing excitation and emission radiation into and out of the sample holder and into the spectrograph.

39. The fluorimetric analyzer of claim 32, wherein the compositional analysis yields an index for the sample, said index comprising information selected from the group consisting of fluorescent quality, an inventory of specific nanotube structures and abundances, a distribution of nanotube diameters and chiral angles, and combinations thereof.

40. The fluorimetric analyzer of claim 32, wherein the sample comprises single-wall carbon nanotubes that are dispersed in an aqueous solution comprising a surfactant.

41. The fluorimetric analyzer of claim 32, wherein the sample comprises single-wall carbon nanotubes that are in a disaggregated state.

42. The fluorimetric analyzer of claim 32, wherein the sample is a single-wall carbon nanotube ink.

43. A method for computationally analyzing single-wall carbon nanotube fluorescence data, the method comprising the steps of:
a) correcting intensities in a raw emission spectrum of single-wall carbon nanotubes to compensate for wavelength-dependent variations in instrumental sensitivity and yield a corrected spectrum;
b) transforming the corrected spectrum from a wavelength scale to an optical frequency scale to yield a transformed emission spectrum; and
c) simulating, using an iterative nonlinear least-squares fitting process, the transformed emission spectrum as a superposition of pre-calculated emission profiles for a wide range of single-wall carbon nanotube species to give a set of amplitudes for the various nanotube species.

44. The method of claim 43 further comprising a step of multiplying the amplitudes by pre-determined sensitivity factors to correct for variations in excitation efficiency among different nanotube species at a relevant excitation wavelength and yield corrected amplitudes for the various nanotube species.

45. The method of claim 44 further comprising a step of adjusting the corrected amplitudes using species-dependent photophysical efficiency factors.
